(19) United States
(12) Patent Application Publication
(10) Pub. No.: US 2025/0019561 A1
(43) Pub. Date: Jan. 16, 2025

(54) SILICON ANODE BINDER

(71) Applicant: SOLVAY SPECIALTY POLYMERS ITALY S.P.A., Bollate (Milano) (IT)

(72) Inventors: Maurizio Biso, Milano (IT); Wojciech Bzducha, Courbevoie (FR); Jean-Christophe Castaing, Sèvres (FR); Stefano Mauri, Giussano (IT); David James Wilson, La Pomarede (FR)

(73) Assignee: SOLVAY SPECIALTY POLYMERS ITALY S.P.A., Bollate (Milano) (IT)

(21) Appl. No.: 18/712,653

(22) PCT Filed: Nov. 18, 2022
(86) PCT No.: PCT/EP2022/082487

§ 371 Date: May 22, 2024

(30) Foreign Application Priority Data
Nov. 22, 2021 (EP) 21306622.8

(51) Int. Cl. C09D 133/26; C08F 220/06; C08F 220/28; C08F 220/56; H01M 4/04; H01M 4/62

(52) U.S. Cl. CPC C09D 133/26; C08F 220/06; C08F 220/286; C08F 220/56; H01M 4/0404; H01M 4/622

(57) ABSTRACT

The present invention relates to a binder for a non-aqueous electrolyte rechargeable battery, a negative electrode slurry for a rechargeable battery, a negative electrode for a rechargeable battery, and a rechargeable battery comprising the same.

### CROSS-REFERENCE TO RELATED APPLICATIONS

This application claims priority to European application number 21306622.8 filed on Nov. 22, 2021, the whole content of this application being incorporated herein by reference for all purposes.

### TECHNICAL FIELD

The present invention relates to a binder for a non-aqueous electrolyte rechargeable battery, a negative electrode slurry for a rechargeable battery, a negative electrode for a rechargeable battery, and a rechargeable battery comprising the same.

### BACKGROUND ART

Non-aqueous electrolyte rechargeable batteries, such as lithium ion rechargeable batteries, are widely used as power sources for electronic devices. High capacity and long cycle-life characteristics are desirable, however current lithium ion batteries are limited in their storage of electrical charge by the capacity of the negative electrode.

As an example of a method for increasing capacity of a lithium ion rechargeable battery, an active material including a silicon atom may be used in a negative electrode.

Silicon has a theoretical capacity of about 4,200 mAh/g, thus being important for application of a high capacity battery in terms of capacity. However, since the volume of silicon expands by about four times when charged, during charging and discharging, the volume expansion causes irreversible reactions, such as destruction of an electrical connection between active materials, separation of an active material from a current collector, and formation of a solid electrolyte interface (SEI) layer due to erosion of the active material by an electrode, and deterioration of service life associated therewith. Moreover, current binders only accommodate limited silicon loading (up to 10 wt. %) before battery lifetime is significantly reduced because of reduced charge cycle stability.

There is much activity presently dedicated to development of new binders for silicon-containing anodes to enable higher energy density storage.

The binder, typically an organic polymer, serves as the connective matrix that maintains contact between active materials throughout the anode layer and with the current collector onto which the anode is deposited during fabrication.

There are many approaches being pursued to develop next generation binders to accommodate silicon anodes.

There are multiple polycarboxylate binders and derivatives being pursued, including polyacrylic acids, polyamic acids, polyacrylamides, and other hydrogen bonding structures.

Miranda, A. et al. (“A Comprehensive Study of Hydrolyzed Polyacrylamide as a Binder for Silicon Anodes” Appl. Mater. Interfaces, 2019, 11, 44090-44100) disclose the use of partially hydrolyzed polyacrylamide in the preparation of composite silicon anodes having good adhesion, high strength and high electrochemical storage capacity.

With respect to polycarboxylates, especially polyacrylic acids, it is also well documented that there are advantages to first convert them to lithium salts by neutralizing with a base such as lithium hydroxide. This is primarily done to avoid sequestration of lithium ions by the free acid groups in the cell, which can diminish the initial capacity.

WO2015/163302 discloses that capacity retention rates after 10 cycles of charging and discharging may be improved by using an aqueous solution of a crosslinked sodium polyacrylate copolymer. Sodium polyacrylate has been used as a water-soluble high-strength, high-elasticity binder. By using sodium polyacrylate, it is expected that volume changes accompanying charging and discharging of a battery including a silicon-containing active material is suppressed or reduced and cycle characteristics may be improved. It is believed, however, that when using an aqueous solution of a copolymer including sodium polyacrylate as the main component, it is difficult in practical terms to apply the aqueous solution of the copolymer including sodium polyacrylate because cracks are generated in the electrode during the coating and drying processes of the negative electrode slurry.

Despite the current strategies to prevent degradation of silicon-rich anodes, there seems to be a limit to which they are effective, with no clear breakthrough yet reaching the higher levels of silicon needed to achieve meaningful advancements in the field. There are numerous disclosures of mixed binder systems to leverage cooperative effects between molecules to boost binder performance.

US 2020/0343556 provides a binder for a non-aqueous electrolyte rechargeable battery including a blend of a first copolymer that includes a unit derived from a (meth) acrylic acid-based monomer, and a unit derived from a (meth) acrylonitrile monomer, and a second copolymer that includes a unit derived from an aromatic vinyl-based monomer, and a unit derived from an ethylenic unsaturated monomer comprising a carboxylic acid moiety. Said binder is capable of suppressing or reducing electrode expansion of the negative electrode, and to improve cycle characteristics.

The Applicant has unexpectedly found that certain polymers obtained by copolymerization of certain monomers with at least one monomer selected from a monomer bearing a carboxylic group and an acrylamide may be used in the preparation of a binder for electrodes, especially for silicon-rich anodes, exhibiting high cycle stability and electrochemical stability.

### SUMMARY OF INVENTION

It is an object of the present invention a terpolymer [polymer (P)] consisting of:
(A1) recurring units derived from an a,B-ethylenically unsaturated carboxylic acid monomer [monomer (AA)] of formula (III)

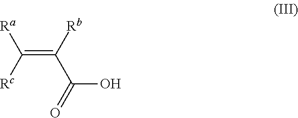

wherein Ra, Rb and Rc, equal to or different from each other, are
independently selected from a hydrogen atom and a C₁-C₃ hydrocarbon group;
(A2) recurring units derived from a (meth) acrylamide monomer [monomer (AM)] of formula (I):

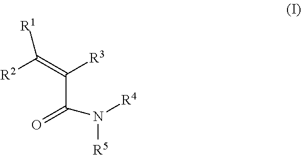

wherein
R¹ and R², being the same or different from each other, may be selected from a hydrogen atom, from a linear or branched alkyl group having 1 to 6 carbon atoms, a carboxylic group or an amide group,
R³ represents a hydrogen atom or a methyl group,
R⁴ and R⁵, being the same or different from each other, may be selected from a hydrogen atom or from a linear or branched alkyl group having 1 to 6 carbon atoms; and
   (B) recurring units derived from a monomer (M), different from monomer (AA) and from monomer (AM), said monomer (M) having the formula (II) below:

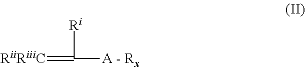

wherein:
Rⁱ is selected from the group consisting of H,—COOH,—CH₂COOH or an alkyl group, wherein the alkyl group is preferably a methyl group;
Rⁱⁱ and Rⁱⁱⁱ, being the same or different from each other, may be selected from a hydrogen atom or from a linear or branched alkyl group having 1 to 6 carbon atoms, or can be —COOH group;
A is a linkage selected from the group consisting of a —C(O)—O-group or a —C(O)—NH-group;

Rₓ is selected from a hydrogen atom or a linear or branched C₃-C₂₀ hydrocarbon chain moiety comprising at least one functional groups selected from the group consisting of ether (—O—), heterocyclic group, sulfonic acid group (—SO₃H), phosphonic acid group (—PO₃H₂) and phosphoric acid group (—OPO₃H₂).

Another object of the invention is an aqueous electrode-forming composition [composition (Comp)] for use in the preparation of electrodes for electrochemical devices, characterized by comprising:
a) at least one polymer (P),
b) an electrode active material,
c) an aqueous solvent, and
d) optionally at least one electroconductivity-imparting additive.

In another object, the present invention provides a process for preparing an electrode [electrode (E)], said process comprising:
(i) providing a metal substrate having at least one surface;
(ii) providing a composition (Comp) as above defined;
(iii) applying the composition (Comp) provided in step (ii) onto the at least one surface of the metal substrate provided in step (i), thereby providing an assembly comprising a metal substrate coated with said composition (Comp) onto the at least one surface;
(iv) drying the assembly provided in step (iii);
(v) submitting the dried assembly obtained in step (iv) to a compression step to obtain the electrode (E) of the invention.

In a further aspect, the present invention pertains to the electrode [electrode (E)] obtainable by the process of the invention.

In still a further object, the present invention pertains to an electrochemical device comprising at least one electrode (E) of the present invention.

### DETAILED DESCRIPTION

In the context of the present invention, the term “percent by weight” (wt. %) indicates the content of a specific component in a mixture, calculated as the ratio between the weight of the component and the total weight of the mixture. When referred to the total solid content (TSC) of a liquid composition, weight percent (wt. %) indicates the ratio between the weight of all non-volatile ingredients in the liquid.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

As known in the art, an electrode forming composition is a composition of matter, typically a fluid composition, wherein solid components are dissolved or dispersed in a liquid, which can be applied onto a metallic substrate and subsequently dried thus forming an electrode wherein the metallic substrate acts as current collector. Electrode forming compositions typically comprise at least an electro active material and at least a binder.

The electrode-forming composition [composition (Comp)] of the present invention comprises at least one polymer (P), which functions as a binder.

The polymer (P)

Polymer (P) can be obtained by radical copolymerization of a mixture of a monomer (M) as above defined, an a,B-ethylenically unsaturated carboxylic acid monomer [monomer (AA)] and a (meth) acrylamide monomer [monomer (AM)], as above defined.

The at least one a,B-ethylenically unsaturated carboxylic acid monomer (AA) of formula (III) as above defined, is preferably selected from the group consisting of acrylic acid, methacrylic acid, ethacrylic acid, crotonic, methyl (meth) acrylic acid, ethyl (meth) acrylic acid, propyl (meth) acrylic acid, isopropyl (meth) acrylic acid, n-butyl (meth) acrylic acid, 2-ethylhexyl (meth) acrylic acid, n-hexyl (meth) acrylic acid and n-octyl (meth) acrylic acid.

The (meth) acrylamide monomer [monomer (AM)] of formula (I) is preferably selected from the group consisting of (meth) acrylamides or N-substituted (meth) acrylamide such as N-alkyl acrylamides, N,N-dialkylacrylamides.

The “heterocyclic group” in residue Rₓ of monomer (M) includes saturated heterocyclic group having at least one nitrogen atom compound, such as imidazolidinone.

According to a first variant wherein A in formula (II) is a —C(O)—O-group, the monomer (M) may for example be a compound of formula (IIa)

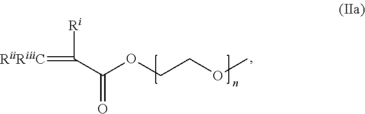

a compound of formula (IIb)

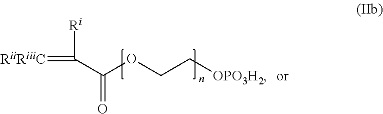

a compound of formula (IIc)

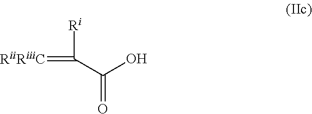

wherein in the formulae (11a) to (Ilc) Rⁱ, Rⁱ and Rili are as above defined,
and n is an integer from 1 to 40.

According to a second variant wherein A in formula (II) is a —C(O)—NH— group, the monomer (M) may for example be a compound of formula (IId)

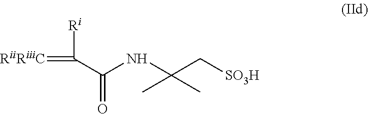

or a compound of formula (11e)

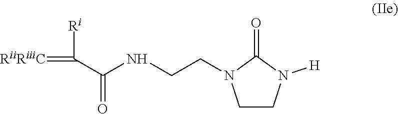

wherein in the formulae (Ild) and (11e) Rⁱ, Rⁱⁱ and Rⁱⁱⁱ are as above defined.

Typically, the polymer (P) is obtained by radical copolymerization of a mixture of:
a monomer (M),
a monomer (AA) and/or
a monomer (AM),
in the presence of a source of free radicals.

Any source of free radicals can be used. It is possible in particular to generate free radicals spontaneously, for example by increasing the temperature, with appropriate monomers, such as styrene. It is possible to generate free radicals by irradiation, in particular by UV irradiation, preferably in the presence of appropriate UV-sensitive initiators. It is possible to use initiators or initiator systems of radical or redox type. The source of free radicals may or may not be water-soluble. It may be preferable to use water-soluble initiators or at least partially water-soluble initiators.

Generally, the greater the amount of free radicals, the more easily the polymerization is initiated (it is promoted) but the lower the molar masses of the copolymers obtained. Use may in particular be made of the following initiators:
peroxides, such as: hydrogen peroxides, tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, tbutyl peroxypivalate, dicumyl peroxide, benzoyl peroxide, potassium persulfate or ammonium persulfate,
azo compounds, such as: 2,2′-azobisisobutyronitrile, 2,2′-azobis (2-butanenitrile), 4,4′-azobis (4-pentanoic acid), 1,1′-azobis (cyclohexanecarbonitrile), 2-(t-butylazo)-2-cyanopropane, 2,2′-azobis {2-methyl-N-[1,1-bis (hydroxymethyl)-2-hydroxyethyl] propionamide}, 2,2′-azobis [2-methyl-N-(hydroxyethyl) propionamide], 2,2′-azobis (N,N′-dimethyleneisobutyramidine) dihydrochloride, 2,2′-azobis (2-amidinopropane) dihydrochloride, 2,2′-azobis (N,N′-dimethyleneisobutyramide), 2,2′-azobis {2-methyl-N-[1,1-bis (hydroxymethyl)-2-hydroxyethyl] propionamide}, 2,2′-azobis {2-methyl-N-[1,1-bis (hydroxymethyl) ethyl] propionamide}, 2,2′-azobis [2-methyl-N-(2-hydroxyethyl) propionamide] or 2,2′-azobis (isobutyramide) dihydrate,
redox systems comprising combinations, such as: mixtures of hydrogen peroxide, alkyl peroxide, peresters, percarbonates and the like and of any iron salt, titanous salt, zinc formaldehydesulfoxylate or sodium formaldehydesulfoxylate, and reducing sugars,
alkali metal or ammonium persulfates, perborates or perchlorates, in combination with an alkali metal bisulfite, such as sodium metabisulfite, and reducing sugars, and
alkali metal persulfates in combination with an arylphosphinic acid, such as benzenephosphonic acid and others of a like nature, and reducing sugars.

The polymerization temperature can in particular be between 25° C. and 95° C. The temperature can depend on the source of free radicals. If it is not a source of UV initiator type, it will be preferable to operate between 50° C. and 95° C., more preferably between 60° C. and 80° C. Generally, the higher the temperature, the more easily the polymerization is initiated (it is promoted) but the lower the molar masses of the copolymers obtained.

According to a preferred embodiment of the present invention, a polymer (P) is obtained by radical polymerization of one monomer (AA), one monomer (AM), and one monomer (M) in the presence of a source of free radicals, in order to obtain a polymer comprising recurring units derived from monomer (AA,) recurring units derived from monomer (AM) and recurring units derived from monomer (M).

Polymer (P) can also be prepared by any controlled radical polymerization. Among these, reversible addition-fragmentation chain transfer (RAFT) and macromolecular design via inter-exchange of xanthate (MADIX) can be mentioned.

The use of RAFT or MADIX controlled radical polymerization agents, hereinafter referred to as “RAFT/MADIX agents”, has been disclosed for instance WO 98/058974 A (RHODIA CHIMIE)30 Dec. 1998 and WO 98/01478 A (E. I. DUPONT DE NEMOURS AND COMMONWEALTH SCIENTIFIC AND INDUSTRIAL RESEARCH ORGANIZATION)15 Jan. 1998.

Preferably, the polymer (P) is obtained by radical copolymerization of a mixture having the following molar ratio, based on the total quantity of monomer (AA), monomer (AM) and monomer (M):
monomer (AA): from 1 to 95%, notably from 5 to 50%, preferably from 20 to 40%,
monomer (AM): from 1 to 90%, preferably from 25 to 90%, more preferably from 60 to 80%,
monomer (M): from 0.1 to 50%, for example from 1 to 30%, notably from 1 to 20% and even 2 to 15%

As a consequence, polymer (P) preferably comprises:
from 1 to 95%, notably from 5 to 50%, preferably from 20 to 40% of recurring units derived from monomer (AA),
from 1 to 90%, preferably from 25 to 90%, more preferably from 50 to 80% of recurring units derived from monomer (AM), and
from 0.1 to 50%, for example from 1 to 30%, notably from 1 to 20% and even 2 to 15% of recurring units derived from monomer (M) all the aforementioned % by moles being referred to the total moles of recurring units of the polymer (P).

In a preferred embodiment of the present invention, polymer (P) comprises:
from 5 to 50%, preferably from 20 to 40% of recurring units derived from monomer (AA),
from 25 to 90%, more preferably from 50 to 80% of recurring units derived from monomer (AM), and
from 0.1 to 50%, for example from 1 to 30%, notably from 1 to 20% and even 2 to 15% of recurring units derived from monomer (M), all the aforementioned % by moles being referred to the total moles of recurring units of the polymer (P).

Besides, the polymer (P) according to the invention preferably has a number average molecular weight (Mn) of at least 90 kDa, for example between 90 and 5000 kDa, preferably from 850 kDa to 2000 kDa.

According to a preferred embodiment, polymer (P) is a statistical (random) copolymer having a weight average molecular weight of about 100 kDa to 10000 kDa, preferably from 1000 kDa to 3000 kDa, which is obtained by radical polymerization of a mixture of monomer (AA), monomer (AM), and a monomer (M), preferably in a molar ratio of about:
from 20 to 40% of monomer (AA),
from 50 to 80% of monomer (AM), and
from 2 to 15% of monomer (M).

According to an embodiment of the invention, polymer (P) is a block copolymer obtained by controlled radical polymerization using RAFT/MADIX agents.

By “block copolymer” as used herein it is intended any controlled-architecture copolymer, including but not limited to true block polymers, which could be di-blocks, tri-blocks, or multi-blocks; branched block copolymers, also known as linear star polymers; comb;
and gradient polymers. Gradient polymers are linear polymers whose composition changes gradually along the polymer chains, potentially ranging from a random to a block-like structure. Each block of the block copolymers may itself be a homopolymer, a random copolymer, a random terpolymer, or a gradient polymer.

Polymer (P) can be provided in solid or dry form or in a vectorized form, for example in the form of a solution or of an emulsion or of a suspension, in particular in the form of an aqueous solution. The vectorized form, for example an aqueous solution, can in particular comprise from 3 to 50% by weight of the polymer (P), for example from 5 to 30% by weight. The aqueous solution comprising polymer (P) can in particular be a solution obtained by an aqueous phase preparation process at the end of a radical polymerization process.

Since polymer (P) comprises recurring units deriving from a monomer (AA), it may suitably be converted into its neutralized form polymer [polymer (P-N)], thus comprising the recurring units derived from the at least an α,β-ethylenically unsaturated carboxylic acid in a neutralized form.

In one embodiment, the present invention thus provides a polymer (P-N), said polymer consisting of:
(A1) recurring units derived from an a,β-ethylenically unsaturated carboxylic acid monomer [monomer (AA)] in neutralized form;
(A2) a (meth) acrylamide monomer [monomer (AM)] of formula (I):

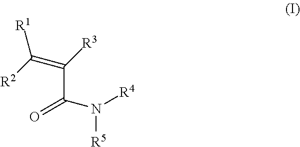

wherein
R¹ and R², being the same or different from each other, may be selected from a hydrogen atom, from a linear or branched alkyl group having 1 to 6 carbon atoms, a carboxylic group or an amide group, R³ represents a hydrogen atom or a methyl group,
R⁴ and R⁵, being the same or different from each other, may be selected from a hydrogen atom or from a linear or branched alkyl group having 1 to 6 carbon atoms; and
   (B) recurring units derived from at least one monomer (M), different from monomer (AA) and from monomer (AM), said monomer (M) having the formula (II) below:

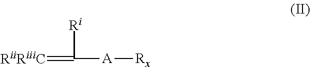

wherein:
Rⁱ is selected from the group consisting of H,—COOH,—CH₂COOH or an alkyl group, wherein the alkyl group is preferably a methyl group; Rⁱⁱ and Rⁱⁱⁱ, being the same or different from each other, may be selected from a hydrogen atom or from a linear or branched alkyl group having 1 to 6 carbon atoms, or can be—COOH group;

A is a linkage selected from the group consisting of a —C(O)—O-group or a —C(O)—NH-group;

Rₓ is selected from a hydrogen atom or a linear or branched C₃-C₂₀ hydrocarbon chain moiety comprising at least one functional groups selected from the group consisting of ether (—O—), heterocyclic group, sulfonic acid group (—SO₃H), phosphonic acid group (—PO₃H₂) and phosphoric acid group (—OPO₃H₂).

Polymer (P-N) can be prepared by neutralizing the acid groups of the recurring units derived from monomer (AA) of polymer (P) as above defined, wherein the neutralization of acid groups is carried out either with a salt [salt(S)] including a monovalent cation, preferably an alkaline metal salt, in a suitable solvent, or with ammonia.

The salt(S) can be any salt capable of neutralizing the acid groups. In some embodiments, the salt(S) is a lithium salt selected from the group consisting of lithium carbonate, lithium hydroxide, lithium bicarbonate, and combinations thereof, preferably lithium carbonate. In some embodiments, the lithium salt is free of lithium hydroxide.

The solvent for use in the step of neutralization of polymer (P) can be any solvent capable of dissolving the salt(S) or ammonia and the resulting polymer (P-N). Preferably, the solvent is selected from at least one of an aqueous solvent, such as water, NMP, and alcohols, such as, for example, methanol, isopropanol, and ethanol. Most preferably, the solvent is an aqueous solvent. Still more preferably the solvent is water.

Preferably the content of the salt(S) in the solvent ranges from 0.5 to 10 wt. %, preferably from 1 to 5 wt. %, based on the total weight of the solvent and the salt(S).

In some embodiments wherein the salt(S) is a lithium salt, the concentration of the lithium salt in the solvent provides at least 0.25 eq, 0.5 eq, 0.8 eq, 1 eq, 1.5 eq, 2 eq, 2.5 eq, 3 eq, 4, eq of lithium to acid groups. In some embodiments, the concentration of the lithium salt in the solvent provides at most 5 eq, preferably at most 4, eq of lithium to acid groups.

According to said embodiments, the polymer (P-N) comprises recurring units derived from the lithiated form of the at least one a, B-ethylenically unsaturated carboxylic acid monomer.

The content of polymer (P-N) in the solution after neutralization, based on the total weight of the solvent and the polymer (P-N), ranges from 0.5 to 40 wt %, preferably from 2 to 30 wt %, more preferably 4 to 20 wt %.

The polymer (P-N) can be isolated as a solid from the solution after neutralization and optionally stored for later use. The solid polymer (P-N) can also be dissolved (or re-dissolved) in water to prepare the electrode-forming composition described below. Preferably, however, the solution including the polymer (P-N) after neutralization is an aqueous solution that can be used directly, optionally with further dilution with water, in preparing binder composition as described below.

In a preferred embodiment, a lithium salt of polymer (P), namely polymer (P-Li) was prepared by adding an amount of LiOH to fully neutralize an aqueous solution containing about 10 wt. % polymer (P). The resulting solution had a pH in the range of 6.5 to 9 and contained approximately 10 wt. % of polymer (P-Li).

The neutralized polymer solution has advantages in the processing and dispersing ability of the slurry because neutralized polymer shows increased viscosity. Moreover, polymer (P-Li) has a pH more compatible with lithiated silicon types that usually show better performance if processed with slurry having a pH higher than 7. An additional advantage is that the salified form of the recurring units derived from the monomer (AA) can avoid sequestration of lithium ions by the free acid groups in the cell, which can diminish the first cycle coulombic efficiency and thus the initial capacity.

The electrode-forming composition [composition (Comp)]

The amount of polymer (P) which may be used in the electrode-forming composition (Comp) is subject to various factors. One such factor is the surface area and amount of the active material, and the surface area and amount of any electroconductivity-imparting additive which are added to the electrode-forming composition. These factors are believed to be important because the binder particles provide bridges between the conductor particles and conductive material particles, keeping them in contact.

The electrode forming composition [composition (Comp)] of the present invention includes one or more electrode active material. For the purpose of the present invention, the term “electrode active material” is intended to denote a compound that is able to incorporate or insert into its structure, and substantially release therefrom, alkaline or alkaline-earth metal ions during the charging phase and the discharging phase of an electrochemical device. The electrode active material is preferably able to incorporate or insert and release lithium ions.

The nature of the electrode active material in the electrode forming composition (Comp) of the invention depends on whether said composition is used in the manufacture of a negative electrode (anode) or a positive electrode (cathode).

In the case of forming a positive electrode for a Lithium-ion secondary battery, the electrode active material may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCO₁₋ₓO₂ (0<x<1) and spinel-structured LiMn204.

As an alternative, still in the case of forming a positive electrode for a Lithium-ion secondary battery, the electrode active material may comprise a lithiated or partially lithiated transition metal oxyanion-based electro-active material of formula M₁M₂ (JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂ (JO₄)_{f}E_{1-f} electro-active material as defined above is preferably phosphate-based and may have an ordered or modified olivine structure.

More preferably, the electrode active material in the case of forming a positive electrode has formula Li₃₋ₓM′_{y}M “_{2-y} (JO₄)₃ wherein 0≤x≤3, 0≤y≤2, M′ and M” are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material is a phosphate-based electro-active material of formula Li (FeₓMn₁₋ₓ) PO₄ wherein O≤x≤1, wherein x is preferably 1 (that is to say, lithium iron phosphate of formula LiFePO₄).

In the case of forming a negative electrode for a Lithium-ion secondary battery, the electrode active material may preferably comprise one or more carbon-based materials and/or one or more silicon-based materials.

In some embodiments, the carbon-based materials may be selected from graphite, such as natural or artificial graphite, graphene, or carbon black. These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide, silicon oxide and lithiated silicon.

More particularly, the silicon-based compound may be silicon oxide or silicon carbide.

When present in the electrode active material, the silicon-based compounds are comprised in an amount ranging from 1 to 70% by weight, preferably from 5 to 30% by weight with respect to the total weight of the electro active compounds.

One or more optional electroconductivity-imparting additives may be added in order to improve the conductivity of a resulting electrode made from the composition of the present invention. Conducting agents for batteries are known in the art.

Examples thereof may include: carbonaceous materials, such as carbon black, graphite fine powder, carbon nanotubes, graphene, or fiber, or fine powder or fibers of metals such as nickel or aluminum. The optional conductive agent is preferably carbon black. Carbon black is available, for example, under the brand names, Super PR or Ketjenblack®.

When present, the conductive agent is different from the carbon-based material described above.

The amount of optional conductive agent is preferably from 0 to 30 wt. % of the total solids in the electrode forming composition. In particular, for cathode forming compositions the optional conductive agent is typically from 0 wt. % to 10 wt. %, more preferably from 0 wt. % to 5 wt. % of the total amount of the solids within the composition.

For anode forming compositions which are free from silicon based electro active compounds the optional conductive agent is typically from 0 wt. % to 5 wt. %, more preferably from 0 wt. % to 2 wt. % of the total amount of the solids within the composition, while for anode forming compositions comprising silicon based electro active compounds it has been found to be beneficial to introduce a larger amount of optional conductive agent, typically from 0.5 to 30 wt. % of the total amount of the solids within the composition.

Further, the electrode-forming composition of the invention can contain at least one thickener; when present, the amount of thickener (also designated as rheology modifier) is not particularly limited and generally ranges between 0.1 and 10 wt %, preferably between 0.5 and 5 wt %, with respect to the total weight of the composition (Comp). The thickener is generally added in order to prevent or slow down the settling of the powdery electrode material from the aqueous composition of the invention, while providing appropriate viscosity of the composition for a casting process.

Non-limitative examples of suitable thickeners include, notably, organic thickeners such as carboxylated alkyl cellulose like carboxylated methyl cellulose and inorganic thickeners such as natural clays like montmorillonite and bentonite, manmade clays like laponite and others like silica and talc.

The total solid content (TSC) of the composition (Comp) of the present invention is typically comprised between 15 and 70 wt. %, preferably from 40 to 60 wt. % over the total weight of the composition (Comp). The total solid content of the composition (Comp) is understood to be cumulative of all non-volatile ingredients thereof, notably including polymer (P), the electrode active material and any solid, non-volatile additional additive such as the thickener.

When the aqueous binder solution is prepared separately and subsequently combined with an electrode active material and optional conductive material and other additives to prepare composition (Comp), an amount of water sufficient to create a stable solution is employed. The amount of water used may range from the minimum amount needed to create a stable solution to an amount needed to achieve a desired total solid content in an electrode mixture after the active electrode material, optional conductive material, and other solid additives have been added.

The electrode (E)

The electrode-forming composition (Comp) of the invention can be used in a process for the manufacture of an electrode [electrode (E)], said process comprising:

(i) providing a metal substrate having at least one surface;

(ii) providing an electrode-forming composition [composition (Comp)] as above defined;

(iii) applying the composition (Comp) provided in step (ii) onto the at least one surface of the metal substrate provided in step (i), thereby providing an assembly comprising a metal substrate coated with said composition (Comp) onto the at least one surface;

(iv) drying the assembly provided in step (iii);

(v) submitting the dried assembly obtained in step (iv) to a compression step to obtain the electrode (E) of the invention.

The metal substrate is generally a foil, mesh or net made from a metal, such as copper, aluminum, iron, stainless steel, nickel, titanium or silver.

Under step (iii) of the process of the invention, the electrode forming composition (Comp) is applied onto at least one surface of the metal substrate typically by any suitable procedures such as casting, printing and roll coating.

Optionally, step (iii) may be repeated, typically one or more times, by applying the electrode forming composition (Comp) provided in step (ii) onto the assembly provided in step (iv).

Under step (iv) of the process of the invention, drying may be performed either under atmospheric pressure or under vacuum. Alternatively, drying may be performed under modified atmosphere, e.g. under an inert gas, typically exempt notably from moisture (water vapour content of less than 0.001% v/v).

The drying temperature will be selected so as to effect removal by evaporation of the aqueous medium from the electrode (E) of the invention.

In step (v), the dried assembly obtained in step (iv) is submitted to a compression step such as a calendaring process, to achieve the target porosity and density of the electrode (E) of the invention.

Preferably, the dried assembly obtained at step (iv) is hot pressed, the temperature during the compression step being comprised from 25° C. and 130° C., preferably being of about 60° C.

Preferred target density for electrode (E) is comprised between 1.4 and 2 g/cc, preferably at least 1.55 g/cc. The density of electrode (E) is calculated as the sum of the product of the densities of the components of the electrode multiplied by their mass ratio in the electrode formulation.

In a further aspect, the present invention pertains to the electrode [electrode (E)] obtainable by the process of the invention.

Therefore the present invention relates to an electrode (E) comprising:
a metal substrate having at least one surface, and
directly adhered onto at least one surface of said metal substrate, at least one layer consisting of a composition comprising:
a) at least one polymer (P),
b) an electrode active material,
c) an aqueous solvent, and
d) optionally at least one electroconductivity-imparting additive.

The composition directly adhered onto at least one surface of said metal substrate corresponds to the electrode forming composition (Comp) of the invention wherein the aqueous solvent has been at least partially removed during the manufacturing process of the electrode, for example in step (iv) (drying) and/or in the compression step (v). Therefore all the preferred embodiments described in relation to the electrode forming compositions (Comp) of the invention are also applicable to the composition directly adhered onto at least one surface of said metal substrate, in electrodes of the invention, except for the aqueous medium removed during the manufacturing process.

In a preferred embodiment of the present invention, the electrode (E) is a negative electrode. More preferably, the negative electrode comprises a silicon based electro active material.

In a further preferred embodiment, the present invention relates to a negative electrode comprising, based on the total weight of the electrode:
0.5 to 15 wt. %, preferably 0.5 to 10 wt. % of the polymer (P),
45 to 95 wt. %, preferably 70 to 90 wt. % of the carbon-based material,
3 to 50 wt. %, preferably 10 to 50 wt. % of the silicon-based material, and
0 to 5 wt. %, preferably 0.5 to 2.5 wt. %, more preferably about 1 wt. % of the electroconductivity-imparting additive.

The electrode (E) of the invention is particularly suitable for use in electrochemical devices, in particular in secondary batteries.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### Examples

RAW MATERIALS
AA: Acrylic Acid available from Aldrich;
AM: Acrylamide monomer (50% water solution) available from SNF;
Itaconic acid available from Aldrich;
SIPOMER WAMII: available from Solvay, 50% in water;
SIPOMER PAM100: available from Solvay;
AMPS (2-acrylamido-2-methyl-1-propanesulfonic acid), available from Aldrich;
MPEGMA750 (methoxy polyoxyethylene methacrylate), available from Evonik, 50% in water under commercial name VISIOMER® MPEG 750 MA W;
Transfer agent: freshly prepared 1% wt. solution in ethanol of RAFT-type transfer agent available as Rhodixan A1 from Solvay;
Sodium persulfate in powder form available from WVR; (10% wt. water solution was prepared just before the polymerization experiment); Sodium formaldehydesulfoxylate in powder form available from Aldrich; (10% wt. water solution was prepared just before the polymerization experiment);
V-50 initiator): (2,2′-Azobis (2-methyl-propionamidine) dihydrochloride) available in powder form from Aldrich; (10% wt. water solution was prepared just before the polymerization experiment);
Lithium hydroxide monohydrate (purity 98%) available from Sigma-Aldrich; (8% wt. water solution was prepared just before the polymerization experiment in case of the example P-1)
Silicon oxide, KSC-1064 commercially available from Shin-Etsu, theoretical capacity is about 2100 mAh/g;
Graphite, ACTILION 2 from Imerys S.A.;
Carbon black, available as SC45 from Imerys S.A.;
Carboxymethylcellulose (CMC), available as MAC 500LC from Nippon Paper;
Styrene-Butadiene Rubber (SBR) suspension (40% wt. in water), available as Zeon® BM-480B from ZEON Corporation;
Electrolyte mixture of LiPF6 1M in EC/DMC 1/1 v/v with 2% wt. VC and 10% wt. F1EC, from Solvionic.

Synthesis procedure of polymers P-1, P-2, P-3, P-4, P-5 and P-5

The synthesis process was conducted in a thermally isolated reactor to minimize the heat exchange with surrounding (Thermos like flask).

The reactor was equipped with a lid containing multiple entries into which were installed a small reflux system, a mechanical stirring system, a nitrogen purge line and a raw materials feed line.

In a first step, all monomers, solvent (water) and optionally a transfer agent, were charged into the reactor and kept under stirring and nitrogen purging for around 1 hour at room temperature. In case of the example P-1 before nitrogen purging step the pH of the reaction mixture was adjusted with LiOH 8% water solution to be pH=2.5. Then, the redox type initiator was added to the reaction mixture. The thermal initiator was also added at same time into the reaction mixture. The initiator was homogenized in the reaction mixture for few minutes with mechanical stirring, then the stirring and nitrogen purge were stopped.

An increase of the reaction mixture temperature from room temperature up to around 80-90° C. was obtained within around half to one hour time as an exothermic effect. Then, the reaction mixture was maintained in the reaction flask for further 24 hours.

The charges of the reagents used for the synthesis of polymers P-1, P-2, P-3, P-4, P-5 and P-5 are given in Table 1 below.

Synthesis procedure of polymers P-6

The whole synthesis was conducted in a reactor equipped with temperature control heating system, a lid containing multiple entries into which were installed a reflux system, a mechanical stirring system, a nitrogen purge line and a raw materials feed line.

In a first step of the polymerization, 10% of the all monomers and 50% of the solvent (water) were charged into the reactor and kept under stirring and nitrogen purging for around 1 hour at room temperature. Then a portion (20% of the total amount) of the thermal initiator being V-50 was added into the reaction mixture. The initiator was homogenized in the reaction mixture with mechanical stirring and the temperature was increased to 65° C. with external heating bath. After 15 minutes of the temperature stabilization at 65° C. the rest of the monomers solubilized in the rest of the solvent (water) were added in continuous feed during 4 hours into the reaction mixture. At half way and at the end of the monomers feed step, the 2 portions of the initiator (each portion being the 20% of total initiator amount) were added in a shot manner. The polymerization reaction heat (exothermic effect) was controlled at 65° C. by external heating/cooling system. Then the reaction mixture temperature was increased to 80° C. during 1 hour, the last pending portion of the initiator was added in shot manner and the reaction was continued for 2 hours. Then the reaction mixture was cooled down to room temperature. The flowable viscous product was further discharged from the reactor and analyzed in view of the Solid Content (1 gram sample heated at 130° C. until stable mass), the residual monomers (HPLC analysis) and the molecular weight distribution (SEC MALS analysis).

The molar ratio of the monomers used for particular polymer examples are provided in Table 1.

TABLE 1

| | Monomers molar ratio | | | | | |
|---|---|---|---|---|---|---|
| Raw material | P-1 | P-2 | P-3 | P-4 | P-5 | P-6 |
| AA | 30.1% | 32.3% | 20.0% | 32.3% | 32.0% | 31.9% |
| AM | 62.0% | 66.7% | 67.0% | 66.7% | 66.0% | 65.7% |
| Sipomer | | | | | | 2.4% |
| WAM II | | | | | | |
| AMPS | 7.9% | | | | | |
| MPEGMA750 | | 1.0% | | | | |
| Itaconic Acid | | | 13.0% | | | |
| Sipomer | | | | 1.0% | 2.0% | |
| PAM100 | | | | | | |

The charges of the reagents used for the synthesis of polymer P-6 are given in Table 2 below.

TABLE 2

| | Quantities used in grams | | | | | |
|---|---|---|---|---|---|---|
| Raw material | P-1 | P-2 | P-3 | P-4 | P-5 | P-6 |
| Water (solvent) | 901.4 | 848.3 | 884.6 | 867.6 | 874.5 | 1411.8 |
| AA | 103.1 | 112.5 | 68.5 | 117.8 | 112.5 | 49.3 |
| AM | 418.8 | 456.8 | 452.4 | 478.4 | 456.8 | 216.9 |
| Sipomer WAM II | — | — | — | — | — | 16.9 |
| AMPS | 63.7 | — | — | — | — | — |
| MPEGMA750 | — | 68.2 | — | — | — | — |
| Itaconic Acid | — | — | 80.3 | — | — | — |
| Sipomer PAM100 | — | — | — | 22.0 | 42.0 | — |
| transfer agent | 5.20 | 5.20 | 5.20 | 5.20 | 5.20 | — |
| Sodium persulfate | 3.00 | 3.00 | 3.00 | 3.00 | 3.00 | — |
| Sodium | 1.50 | 1.50 | 1.50 | 1.50 | 1.50 | — |
| formaldehydesulfoxylate | | | | | | |
| V-50 initiator | 4.50 | 4.50 | 4.50 | 4.50 | 4.50 | 5.10 |

The flowable high viscous gel like products were then discharged from the flask and analyzed in order to obtain their Solids Content (1 gram sample heated at 130° C. until stable masse), the residual monomers (HPLC analysis) and the molecular weight distribution (SEC MALS analysis).

The characteristics of the polymers P-1 to P-6 are summarized in Table 3.

TABLE 3

| Properties | P-1 | P-2 | P-3 | P-4 | P-5 | P-6 |
|---|---|---|---|---|---|---|
| Molecular weight MW | 1900 | 1700 | | | | 1000 |
| kDa | | | | | | |
| Solid Content (130° | 25 | 25 | 25 | 25 | 25 | 10 |
| C.; 1 hour; 1 g) % wt. | | | | | | |
| Residual monomers | <0.5 | <0.5 | <0.5 | <0.5 | <0.5 | <0.5 |
| (total) % | | | | | | |

Molecular weight determination

The mass distribution of the polymers was measured by SEC MALS analysis (SEC: Size Exclusion Chromatography-MALS: Multi-Angle

Laser Scattering) in order to obtain the real values, expressed in g/mol.

The SEC MALS analysis was performed with an HPLC chain equipped with 2 detectors:
Differential refractometer RI-the concentration detector
MALS detector (Multi-Angle Laser Scattering)-the mass detector.

### General Procedure for Preparation of Water Solutions of Li-Polymer

About 40 g of polymer aqueous solution 5 wt. % was titrated with a LiOH aqueous solution (4.25% by weight of LiOH in water) using a titrator T5 from Mettler Toledo until the desired value of pH.

Preparation of Electrode-Forming Compositions and Negative Electrodes

Electrode-forming compositions and negative electrodes were prepared as detailed below using the following equipment:
Mechanical mixer: planetary mixer (Speedmixer) and high shear mechanical mixer of the Dispermat® series with inclined impeller; Film coater/doctor blade: Elcometer® 4340 motorised/Zehntner ZUA2000;
Vacuum oven: BINDER VD 23 with vacuum; and Roll press: precision 4″ hot rolling press/calender up to 100° C.

### Example 1-Terpolymer Anode 3% Binder

An aqueous composition was prepared by mixing 22.0 g of a 2% by weight solution of CMC, in water, 0.44 g of carbon black, 8.448 g of silicon oxide, 33.792 g of graphite and 17.790 g of deionized water. After moderate stirring in the planetary mixer for 10 min, 17.53 g of 5% solid content solution in water of polymer P-3 was added. The mixture was homogenized by moderate stirring in a planetary mixer for 10 min and then mixed again by moderate stirring for 1 h. After 1 h, the shear is reduced and the slurry mixed again by low stirring.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 60 μm. The electrode was then hot pressed at 60° C. in a roll press to achieve target density of 1.6 g/cc. The resulting negative electrode had the following composition: 19.2 wt. % of silicon oxide, 76.8 wt. % of graphite, 2 wt. % of Itaconic acid (content 21.4%-id48), 1 wt. % of CMC and 1 wt. % of carbon black. Electrode E1 was thus obtained. Electrode quality is good enough for cell testing.

### Example 2-Terpolymer Anode 3% Binder

An aqueous composition was prepared by mixing 22.0 g of a 2% by weight solution of CMC, in water, 0.44 g of carbon black, 8.448 g of silicon oxide, 33.792 g of graphite and 26.153 g of deionized water. After moderate stirring in the planetary mixer for 10 min, 9.167 g of 9.6% solid content solution in water of polymer P-6 was added. The mixture was homogenized by moderate stirring in a planetary mixer for 10 min and then mixed again by moderate stirring for 1 h. After 1 h, the shear is reduced and the slurry mixed again by low stirring.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 60 μm. The electrode was then hot pressed at 60° C. in a roll press to achieve target density of 1.6 g/cc. The resulting negative electrode had the following composition: 19.2 wt. % of silicon oxide, 76.8 wt. % of graphite, 2 wt. % of Sipomer WAMII (content 2.5%-id56), 1 wt. % of CMC and 1 wt. % of carbon black. Electrode E2 was thus obtained. Electrode quality is good enough for cell testing.

### Example 3-Terpolymer Anode 3% Binder

An aqueous composition was prepared by mixing 20.0 g of a 2% by weight solution of CMC, in water, 0.40 g of carbon black, 7.52 g of silicon oxide, 30.080 g of graphite and 10.127 g of deionized water. After moderate stirring in the planetary mixer for 10 min, 31.873 g of 5% solid content solution in water of polymer P-1 was added. The mixture was homogenized by moderate stirring in a planetary mixer for 10 min and then mixed again by moderate stirring for 1 h. After 1 h, the shear is reduced and the slurry mixed again by low stirring.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 60 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 4 wt. % of AMPS (content 20%-id27), 1 wt. % of CMC and 1 wt. % of carbon black. Electrode E3 was thus obtained. Electrode quality is good enough for cell testing.

### Example 4-Terpolymer Anode 3% Binder

An aqueous composition was prepared by mixing 20.0 g of a 2% by weight solution of CMC, in water, 0.40 g of carbon black, 7.52 g of silicon oxide, 30.080 g of graphite and 10.127 g of deionized water. After moderate stirring in the planetary mixer for 10 min, 31.873 g of 5% solid content solution in water of polymer P-2 was added. The mixture was homogenized by moderate stirring in a planetary mixer for 10 min and then mixed again by moderate stirring for 1 h. After 1 h, the shear is reduced and the slurry mixed again by low stirring.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 60 μm. The electrode was then hot pressed at 60° C. in a roll press to achieve target density of 1.6 g/cc. The resulting negative electrode had the following composition: 18.8 wt. % of silicon oxide, 75.2 wt. % of graphite, 4 wt. % of MPEGMa (content 10%-id30), 1 wt. % of CMC and 1 wt. % of carbon black. Electrode E4 was thus obtained. Electrode quality is good enough for cell testing.

### Comparative Example CE1: Negative Electrode Including Styrene-Butadiene Rubber (SBR) and Carboxymethyl Cellulose (CMC)

An aqueous composition was prepared by mixing 25.0 g of a 2% by weight solution of CMC, in water, and 0.50 g of carbon black; after moderate stirring in planetary mixer for 10 min, 9.60 g of silicon oxide 38.4 g of graphite and 23.861 g of deionized water were added. The mixture was homogenized by moderate stirring in a planetary mixer for 10 min and then mixed again by moderate stirring for 1h.

After about 1h of mixing, 2.639 g of SBR suspension was added to the composition and mixed again by low stirring for 1h.

A negative electrode was obtained by casting the binder composition thus obtained on a 18.5 μm thick copper foil with a doctor blade and drying the coating layer in an oven at temperature of 90° C. for about 70 minutes. The thickness of the dried coating layer was about 60 μm. The electrode was then hot pressed at 60° C. in a roll press to achieve target density of 1.6 g/cc. The resulting negative electrode had the following composition: 19.2 wt. % of silicon oxide, 76.8 wt. % of graphite, 2 wt. % of SBR, 1 wt. % of CMC and 1 wt. % of carbon black. Electrode CE1 was thus obtained. Electrode quality is good enough for cell testing.

Manufacture of Batteries

Coin cells (CR²⁰³² type, 20 mm diameter) were prepared in a glove box under an Ar gas atmosphere by punching a small disk of the negative electrode prepared according to E1, E2, E3, E4 and CE1 together a balanced NMC positive electrode disk, purchased from CUSTOMCELLS. The electrolyte used in the preparation of the coin cells was a mixture of 1M LiPF6 solution in EC/DMC 1/1 v/v with 2% wt VC and 10% wt F1EC, from Solvionic; polyethylene separators (commercially available from Tonen Chemical Corporation) were used as received.

Capacity Retention Testing

Full cell cycling stability at 1C C-rate (Open capacities were measured in triplicate and are shown in Table 4 below):

TABLE 4

| | Initial | Capacity retention | Capacity retention |
|---|---|---|---|
| | capacity | after 100 cycles | after 200 cycles |
| Electrode | (mAh/g) | (mAh/g) | (mAh/g) |
| E1 | 132 | 102 | 98 |
| E2 | 132 | 100 | 96 |
| E3 | 130 | 106 | 102 |
| E4 | 131 | 102 | 97 |
| CE1 | 101 | 82 | 77 |

The results show that the discharge capacity retention in batteries comprising the electrodes of the present invention is surprisingly much higher than that of a battery prepared by using the electrode of Comparative Example 1.

1. A terpolymer [polymer (P)] consisting of:
(A1) recurring units derived from an α,β-ethylenically unsaturated carboxylic acid monomer [monomer (AA)] of formula (III) 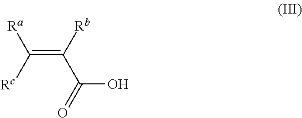
wherein Ra, Rb and Rc, equal to or different from each other, are independently selected from a hydrogen atom and a C₁-C₃ hydrocarbon group;
(A2) recurring units derived from a (meth) acrylamide monomer [monomer (AM)] of formula (I): 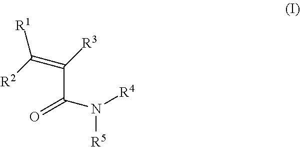
wherein
R¹ and R², being the same or different from each other, may be selected from a hydrogen atom, from a linear or branched alkyl group having 1 to 6 carbon atoms, a carboxylic group or an amide group,
R³ represents a hydrogen atom or a methyl group,
R⁴ and R⁵, being the same or different from each other, may be selected from a hydrogen atom or from a linear or branched alkyl group having 1 to 6 carbon atoms; and
(B) recurring units derived from a monomer (M), different from monomer (AA) and from monomer (AM), said monomer (M) having the formula (II) below: 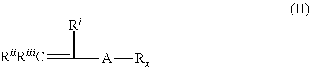
wherein:
Rⁱ is selected from the group consisting of H,—COOH,—CH₂COOH, and an alkyl group; wherein the alkyl group is preferably a methyl group;
Rⁱⁱ and R^{iii,} being the same or different from each other, may be selected from a hydrogen atom or from a linear or branched alkyl group having 1 to 6 carbon atoms, or can be—COOH group;
A is a linkage selected from the group consisting of a —C(O)—O-group and a —C(O)-NH-group;
Rₓ is selected from a hydrogen atom or a linear or branched C₃-C₂₀ hydrocarbon chain moiety comprising at least one functional groups selected from the group consisting of ether (—O—), heterocyclic group, sulfonic acid group (—SO₃H), phosphonic acid group (-PO₃H₂) and phosphoric acid group (—OPO₃H₂).

2. The polymer (P) according to claim 1, wherein the monomer (M) is selected from the group consisting of:
a compound of formula (IIa) 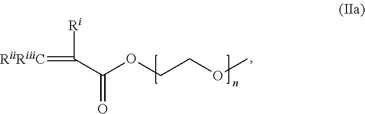
a compound of formula (IIb) 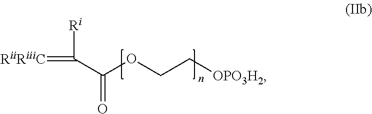
and
a compound of formula (IIc) 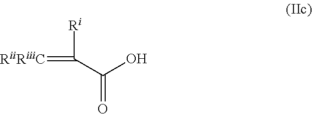
wherein in the formulae (Ila) to (IIc) n is an integer from 1 to 15.

3. The polymer (P) according to claim 1, wherein the monomer (M) is selected from the group consisting of:
a compound of formula (IId) 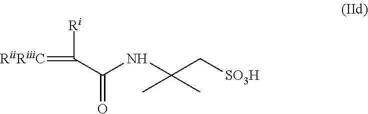
and
a compound of formula (IIe)

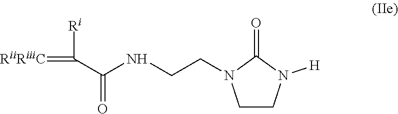

4. The polymer (P) according to claim 1,
wherein monomer (AA) of formula (III) is selected from the group consisting of acrylic acid, methacrylic acid, ethacrylic acid, crotonic acid, methyl (meth) acrylic acid, ethyl (meth) acrylic acid, propyl (meth) acrylic acid, isopropyl (meth) acrylic acid, n-butyl (meth) acrylic acid, 2-ethylhexyl (meth) acrylic acid, n-hexyl (meth) acrylic acid and n-octyl (meth) acrylic acid.

5. The polymer (P) according to claim 1, wherein the (meth) acrylamide monomer [monomer (AM)] of formula (I) is selected from the group consisting of (meth) acrylamides [or] and N-substituted (meth) acrylamide.

6. The polymer (P) according to claim 1, which comprises:
1 from 1 to 95% of recurring units derived from monomer (AA),
from 1 to 90% of recurring units derived from monomer (AM), and 1 from 0.1 to 50% of recurring units derived from monomer (M),
all the aforementioned % by moles being referred to the total moles of recurring units of the polymer (P).

7. The polymer (P) according to claim 6, which comprises:
from 5 to 50% of recurring units derived from monomer (AA),
from 25 to 90% of recurring units derived from monomer (AM), and
from 0.1 to 50% of recurring units derived from monomer (M),
all the aforementioned % by moles being referred to the total moles of recurring units of the polymer (P).

8. A polymer (P) according to claim 1, wherein monomer (AA) is in its neutralized form.

9. The polymer (P) according to claim 9 wherein the neutralized form of monomer (AA) is the lithiated form.

10. An aqueous electrode-forming composition [composition (Comp)] characterized by comprising:
a) at least one polymer (P) according to claim 1,
b) an electrode active material,
c) an aqueous solvent, and
d) optionally at least one electroconductivity-imparting additive.

11. The composition (Comp) according to claim 10, wherein the composition further includes at least one thickener.

12. A process for preparing an electrode [electrode (E)], said process comprising:
(i) providing a metal substrate having at least one surface;
(ii) providing a composition (Comp) according to claim 10;
(iii) applying the composition (Comp) provided in step (ii) onto the at least one surface of the metal substrate provided in step (i), thereby providing an assembly comprising a metal substrate coated with said composition (Comp) onto the at least one surface;
(iv) drying the assembly provided in step (iii);
(v) submitting the dried assembly obtained in step (iv) to a compression step to obtain the electrode (E) of the invention.

13. An electrode [electrode (E)] obtained by the process according to claim 12.

14. An electrochemical device comprising at least one electrode (E) according to claim 13.

15. The polymer (P) of claim 1, wherein Rⁱ is selected from the group consisting of H,—COOH,—CH₂COOH, and a methyl group.

16. The polymer (P) according to claim 7, which comprises:
from 20 to 40% of recurring units derived from monomer (AA),
from 50 to 80% of recurring units derived from monomer (AM), and
from 1 to 30% of recurring units derived from monomer (M),
all the aforementioned % by moles being referred to the total moles of recurring units of the polymer (P).

17. The polymer (P) according to claim 16, which comprises:
from 20 to 40% of recurring units derived from monomer (AA),
from 50 to 80% of recurring units derived from monomer (AM), and
from 1 to 20% of recurring units derived from monomer (M),
all the aforementioned % by moles being referred to the total moles of recurring units of the polymer (P).

18. The polymer (P) according to claim 17, which comprises:
from 20 to 40% of recurring units derived from monomer (AA),
from 50 to 80% of recurring units derived from monomer (AM), and
from 2 to 15% of recurring units derived from monomer (M), all the aforementioned % by moles being referred to the total moles of recurring units of the polymer (P).
